(19) United States
(12) Patent Application Publication
(10) Pub. No.: US 2024/0305970 A1
(43) Pub. Date: Sep. 12, 2024

(54) SCAN PHASE PROCEDURES FOR LOGICAL AP MLD OPERATION

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Plano, TX (US); Yue Qi, Plano, TX (US); Elliot Jen, Taipei City (TW)

(21) Appl. No.: 18/595,086

(22) Filed: Mar. 4, 2024

Related U.S. Application Data
(60) Provisional application No. 63/450,302, filed on Mar. 6, 2023.

(51) Int. Cl. H04W 8/08; H04W 48/16

(52) U.S. Cl. CPC H04W 8/08; H04W 48/16

(57) ABSTRACT

Methods and apparatuses for enhancing a scan phase for efficient mobility handling. A method of wireless communication performed by a non-access point (AP) multi-link device (MLD) (non-AP MLD) that includes stations (STAs) comprises: forming a link with a corresponding AP of an AP MLD, wherein the AP MLD comprises a plurality of APs that form a logical AP MLD; initiating a scan phase procedure over the link between the non-AP MLD and the corresponding AP to request information about the APs that form the logical AP MLD; and receiving a response from the corresponding AP based on the scan phase procedure, the response including information related to roaming received by the corresponding AP from other APs of the logical AP MLD.

### CROSS-REFERENCE TO RELATED APPLICATION AND CLAIM OF PRIORITY

This application claims priority under 35 U.S.C. § 119(e) to U.S. Provisional Patent Application No. 63/450,302 filed on Mar. 6, 2023, which is hereby incorporated by reference in its entirety.

### TECHNICAL FIELD

This disclosure relates generally to transmission efficiency in wireless communications systems that include multi-link devices. Embodiments of this disclosure relate to methods and apparatuses for enhancing the scan phase for efficient mobility handling.

### BACKGROUND

Wireless local area network (WLAN) technology allows devices to access the internet in the 2.4 GHZ, 5 GHZ, 6 GHZ, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Multi-link operation (MLO) is a feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-access point (AP) multi-link device (MLD) to discover, authenticate, associate, and set up multiple links with an AP MLD. Channel access and frame exchange is possible on each link between the AP MLD and non-AP MLD.

### SUMMARY

Embodiments of the present disclosure provide methods and apparatuses for enhancing the scan phase for efficient mobility handling.

In one embodiment, a method of wireless communication performed by a non-access point (AP) multi-link device (MLD) (non-AP MLD) that includes stations (STAs) is provided, comprising: forming a link with a corresponding AP of an AP MLD, wherein the AP MLD comprises a plurality of APs that form a logical AP MLD; initiating a scan phase procedure over the link between the non-AP MLD and the corresponding AP to request information about the APs that form the logical AP MLD; and receiving a response from the corresponding AP based on the scan phase procedure, the response including information related to roaming received by the corresponding AP from other APs of the logical AP MLD.

In another embodiment, a non-AP MLD is provided, comprising: STAs, each comprising a transceiver. The non-AP MLD further comprises a processor operably coupled to the transceiver, the processor configured to: form a link with a corresponding AP of an AP MLD via one or more of the transceivers, wherein the AP MLD comprises a plurality of APs that form a logical AP MLD; initiate a scan phase procedure over the link between the non-AP MLD and the corresponding AP to request information about the APs that form the logical AP MLD; and receive, via the one or more transceivers, a response from the corresponding AP based on the scan phase procedure, the response including information related to roaming received by the corresponding AP from other APs of the logical AP MLD.

In yet another embodiment, an AP MLD is provided, comprising: a plurality of APs, each comprising a transceiver configured to communicate over a link with a corresponding STA of a non-AP MLD, wherein the plurality of APs form a logical AP MLD. The AP MLD further comprises a processor operably coupled to the transceiver, the processor configured to: receive, via one or more of the transceivers, a scan phase procedure request over the link between the AP MLD and the corresponding STA to request information about the APs that form the logical AP MLD; and transmit a response to the corresponding STA based on the scan phase procedure, the response including information related to roaming received from other APs of the logical AP MLD.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP according to embodiments of the present disclosure;

FIG. 2B illustrates an example STA according to embodiments of the present disclosure;

FIG. 3 illustrates an example of stages involved during a mobility handover procedure according to embodiments of the present disclosure;

FIG. 4 illustrates an example logical AP MLD according to embodiments of the present disclosure;

FIG. 5A illustrates an example method for requesting frame information according to embodiments of the present disclosure;

FIG. 5B illustrates an example method for responding to a request for frame information according to embodiments of the present disclosure;

FIG. 6 illustrates an example method for sending a probe request according to embodiments of the present disclosure;

FIG. 7 illustrates an example method for sending a response frame according to embodiments of the present disclosure;

FIG. 8 illustrates an example method for designating a scanner STA according to embodiments of the present disclosure;

FIG. 9 illustrates another example method for designating a scanner STA according to embodiments of the present disclosure; and

FIG. 10 illustrates an example of a method for wireless communication performed by a non-AP device according to embodiments of the present disclosure.

### DETAILED DESCRIPTION

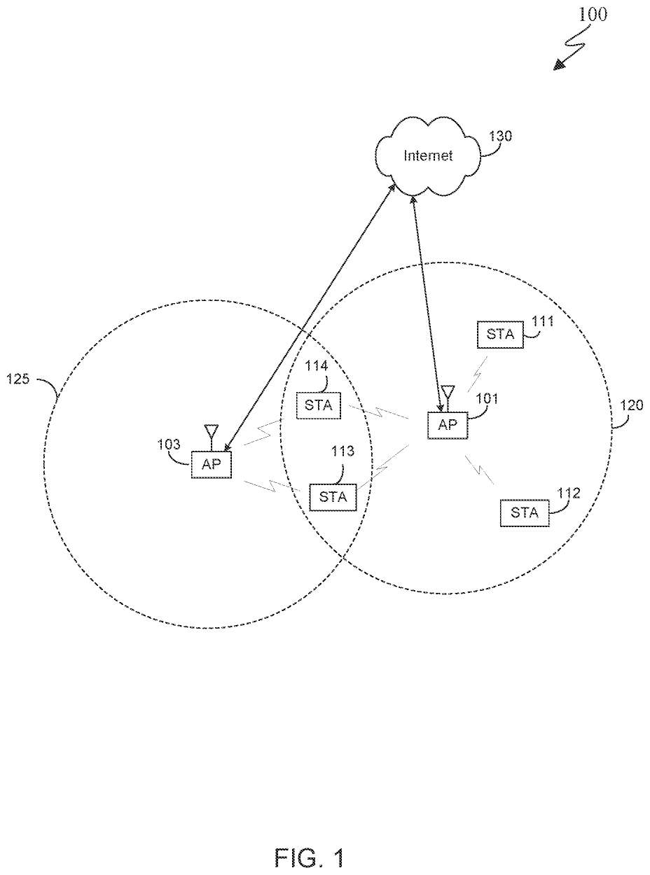

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D3.0, 2023; [2] IEEE std. 802.11-2020.

Embodiments of the present disclosure provide mechanisms for enhancing the scan phase for efficient mobility handling.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for traffic urgency indication. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

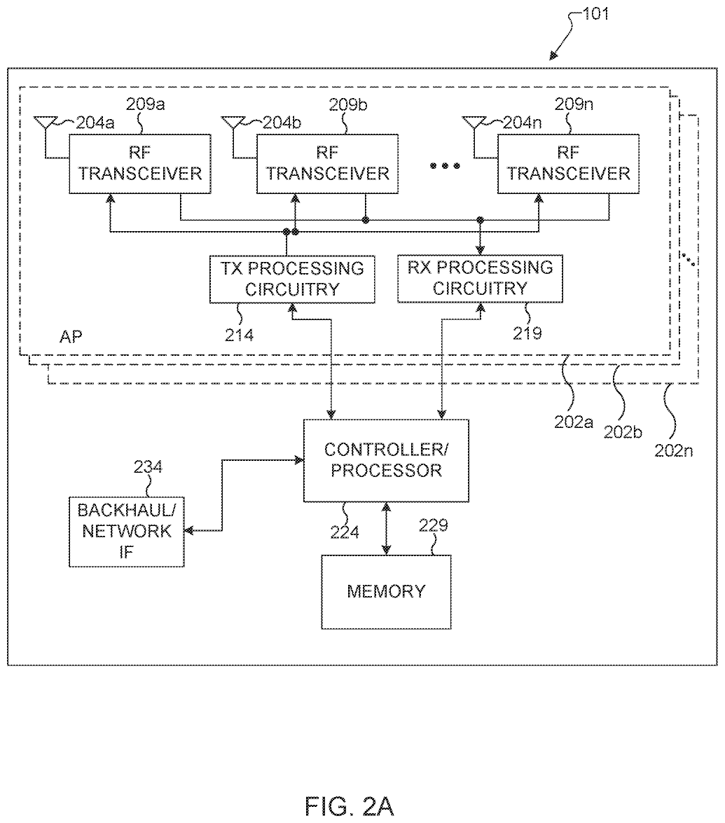

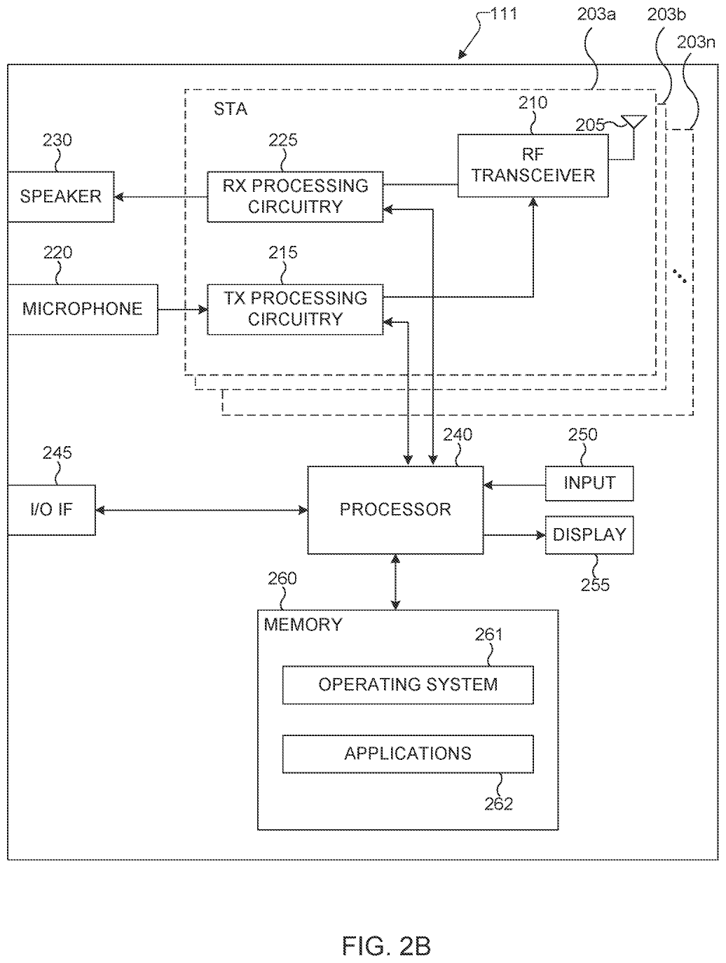

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including enhancing the scan phase for efficient mobility handling. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for enhancing the scan phase for efficient mobility handling. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to support enhancing the scan phase for efficient mobility handling. In some embodiments, the controller/processor 240 includes at least one microprocessor or microcontroller.

The controller/processor 240 is also capable of executing other processes and programs resident in the memory 260, such as operations for supporting enhancing the scan phase for efficient mobility handling. The controller/processor 240 can move data into or out of the memory 260 as required by an executing process. In some embodiments, the controller/processor 240 is configured to execute a plurality of applications 262, such as applications for supporting enhancing the scan phase for efficient mobility handling. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

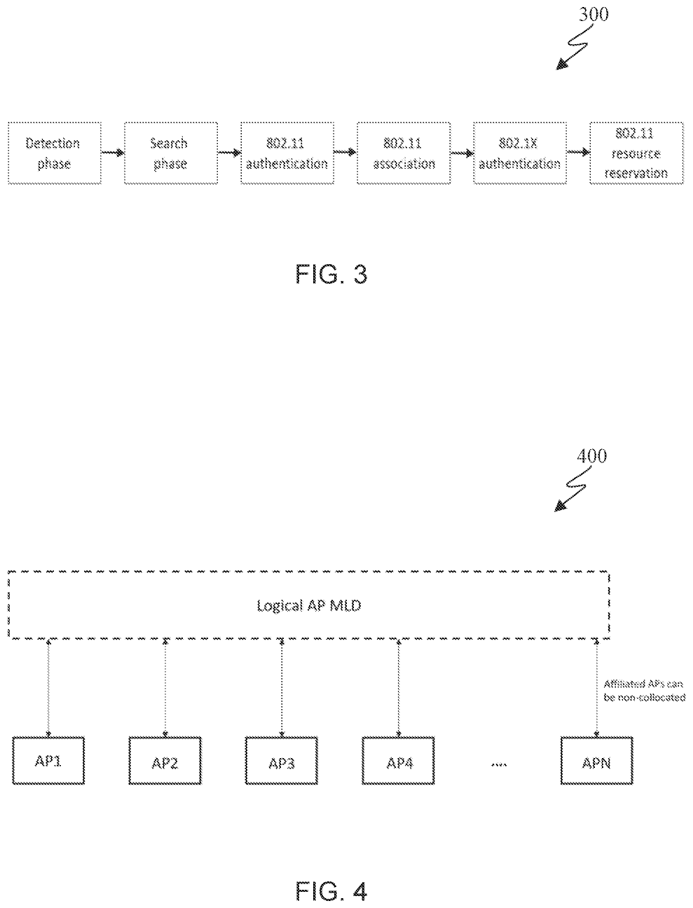

FIG. 3 illustrates an example of stages involved during a mobility handover procedure 300 according to embodiments of the present disclosure. The embodiment of the stages involved during a mobility handover procedure 300 shown in FIG. 3 is for illustration only. Other embodiments of the example stages involved during a mobility handover procedure 300 could be used without departing from the scope of this disclosure.

As users move around, the signal strength of a STA to its connected AP can vary. If user movement causes a significant decrease in the signal strength, a handover is necessary. During the process of handover, the STA switches from its current associated AP to a new AP.

As shown in FIG. 3, in legacy devices without any mobility support, the handover procedure involves the following steps:

1. Detection phase: during the detection phase, the STA determines that there is a need for a handover. The exact procedure to detect a need for handover is beyond the scope of the standard and is left to vendor implementation. For instance, a particular vendor implementation can choose to trigger handover when the signal strength to the currently associated AP drops below a certain threshold.

2. Search phase: the detection phase is followed by a search phase. During the search phase, the STA searches for new APs to associate with. During the search phase, the STA performs a scan of different channels to identify APs in the vicinity. This can be done either passively (e.g., listening to beacons on a particular channel) or actively (e.g., by the use of probe request and response procedure). Passive scan can take a lot of time as the scanning STA needs to wait on each channel for a sufficient amount of time to ensure that the beacon is received from APs on that channel. Since each AP transmits beacons after a certain period of time (e.g., 100 ms), passive scan can consume a lot of time. In the case of active scan, the STA transmits a probe request and waits for a probe response from APs in the vicinity. Without prior knowledge of APs in the vicinity, active scan can take several seconds to complete.

3. 802.11 authentication: after the scanning procedure is complete, the next step is to perform 802.11 authentication (open system/shared key based).

4. 802.11 association: Once the STA is authenticated, the next step is to perform association.

5. 802.1X authentication: Introduced in IEEE 802.1i amendment, this phase comprises an EAP authentication between the STA and a AAA server with the assistance of the AP.

6. 802.11 resource reservation: Finally, the STA sets up various resources at the new AP. For example, the STA can perform QoS reservation, BA setup, etc. with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

In order to reduce the handover delay, a number of procedures have been introduced in several standards. The focus of these procedures is to remove/reduce the delay encountered in various steps of the handover procedure. In 2008, IEEE 802.11r introduced a fast transition roaming which eliminates the need for the authentication step (step 3 above) during the handover. In 2011, IEEE 802.11k introduced assisted roaming which reduces the search phase (step 2 above) by allowing the STA to request the AP to send channel information of candidate neighbor APs. In 2011, IEEE 802.11v also introduced network assisted roaming to assist the search phase. Thus, with a combination of IEEE 802.11v and IEEE 802.11k support, the search time can be reduced by enabling the device to scan only those channels on which APs in the vicinity operate. In IEEE 802.11be, the fast BSS transition procedure was extended to cover the case of MLO operation. This procedure helps to reduce the delays encountered due to 802.11 resource reservation (step 6 above).

However, the STA still needs to perform the association and authentication phases which can take 10 s of ms. In UHR-SG, a target for low-latency with high reliability support is being targeted. In order to meet this goal, the concept of a logical AP MLD is provided.

FIG. 4 illustrates an example logical AP MLD 400 according to embodiments of the present disclosure. The embodiment of the example logical AP MLD 400 shown in FIG. 4 is for illustration only. Other embodiments of the example logical AP MLD 400 could be used without departing from the scope of this disclosure.

As depicted in FIG. 4, a logical AP MLD is made up of several APs which can be non-collocated. This is different from the concept of AP MLD in IEEE 802.11be which considers collocated APs affiliated with an AP MLD.

As depicted in FIG. 4, AP 1 to AP N can be non-collocated. Further, one or more of these APs can have a common data path to a router or a central controller. The APs shown in FIG. 4 can form a logical AP MLD. This new concept of AP MLD is expected to reduce the delays of association and authentication steps mentioned above as the STA may not need to perform association and authentication during handover.

Various embodiments of the present disclosure recognize that the logical AP MLD framework is expected to provide a seamless roaming experience in next generation Wi-Fi networks. However, during the handover process, the scan phase can become a bottleneck and can cause significant delays as the STA scans for APs in the vicinity for the purpose of target AP selection. This can potentially diminish the benefits of the logical AP MLD framework by causing interruptions in user service. Thus, it is important to enhance and reduce the delays of the scan phase for efficient logical AP MLD operation.

Further, various embodiments of the present disclosure recognize that with the logical AP MLD setup, the non-AP MLD can now request a comprehensive set of information about the APs in the vicinity once they are a part of the logical AP MLD (e.g., queuing delays per AC). Procedures to enable such a detailed information exchange can be beneficial for the non-AP MLD.

Accordingly, various embodiments of the present disclosure provide mechanisms for enhancing the scan phase for efficient mobility handling. The solutions can enhance the scanning procedure for target AP MLD search and also reduce the overhead involved in the procedure.

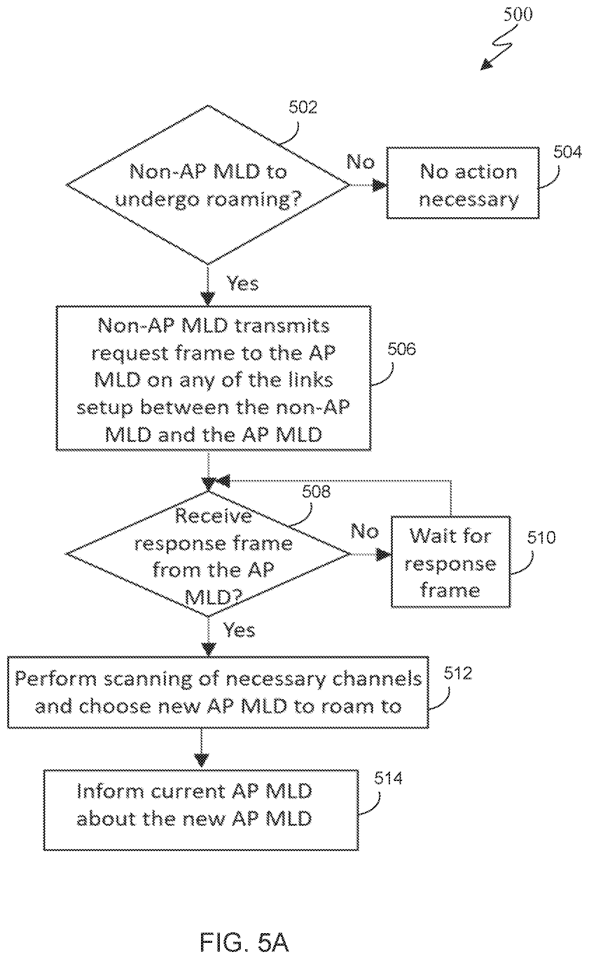

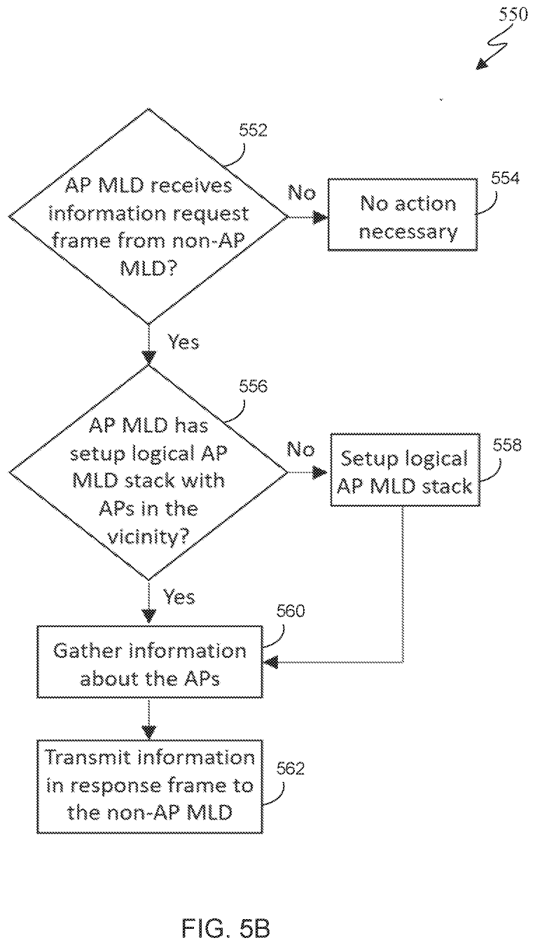

FIG. 5A illustrates an example method 500 for requesting frame information according to embodiments of the present disclosure. The embodiment of the example method 500 for requesting frame information shown in FIG. 5A is for illustration only. Other embodiments of the example method 500 for requesting frame information could be used without departing from the scope of this disclosure.

According to one embodiment, the logical AP MLD's assistance can be used during the scan phase.

According to one embodiment, a non-AP MLD can request information about APs in the vicinity from the current AP MLD that it is associated with. This list of APs can also be the APs that are recommended for the non-AP MLD. The non-AP MLD can then use this information to choose a candidate AP/AP MLD to roam to. This procedure can be as depicted in FIG. 5A.

As illustrated in FIG. 5A, the method 500 begins at step 502, where a determination is made whether the non-AP MLD is to undergo roaming. If the non-AP MLD is not to undergo roaming, then no action is necessary as illustrated at step 504. If the non-AP MLD is to undergo roaming, then at step 506, the non-AP MLD transmits a request frame to the AP MLD on any of the links setup between the non-AP MLD and the AP MLD. At step 508, a determination is made whether a response frame is received from the AP MLD. If a response frame is not received from the AP MLD, then at step 510, the non-AP MLD waits for a response frame and the method reverts to step 508. If a response frame is received from the AP MLD, then at step 512, the non-AP MLD can perform scanning of channels and choose a new AP MLD to roam to. At step 514, the non-AP MLD can inform the current AP MLD about the new AP MLD.

Further, according to this embodiment, upon receiving a request from the non-AP MLD, the current AP MLD can obtain information about APs in the vicinity as depicted in FIG. 5B. The current AP MLD can obtain this information by communicating with APs that are a part of the logical AP MLD stack or by setting up a logical AP MLD stack on demand with APs in the vicinity. Upon obtaining the information about APs in the vicinity, the current AP MLD can transmit that information in a response frame to the non-AP MLD.

FIG. 5B illustrates an example method 550 for responding to a request for frame information according to embodiments of the present disclosure. The embodiment of the example method 550 for responding to a request for frame information shown in FIG. 5B is for illustration only. Other embodiments of the example method 550 for responding to a request for frame information could be used without departing from the scope of this disclosure.

As illustrated in FIG. 5B, the method 550 begins at step 552, where a determination is made whether the AP MLD receives an information request frame from the non-AP MLD. If the AP MLD does not receive the information request, then no action is necessary as illustrated at step 554. If the AP MLD receives the information request frame from the non-AP MLD, then at step 556, a determination is made whether the AP MLD has setup a logical AP MLD stack with APs in the vicinity. If the AP MLD has not setup a logical AP MLD stack with APs in the vicinity, then at step 558, the AP MLD can setup the logical MLD stack and the method proceeds to step 560. If the AP MLD has setup a logical AP MLD stack with APs in the vicinity, then at step 560, the AP MLD can gather information about the APs in the vicinity. At step 562, the AP MLD can transmit information in a response frame to the non-AP MLD.

According to one embodiment, the request message transmitted by the non-AP MLD to the current AP MLD can contain at least one or more of the information fields as shown in Table 1.

TABLE 1
Information fields that can be present in the request frame

| Information | |
|---|---|
| field | Description |
| Reason | A field to indicate the reason for information |
| information | request. E.g., a reason code for the purpose |
| | of roaming, requesting a list of recommended |
| | APs, etc. |
| Information | A field to indicate which information is being |
| requested | requested by the STA. For instance, this |
| | can either be a bitmap where each bit can |
| | correspond to a certain information |
| | (e.g., operating channel) about the APs in the |
| | vicinity and if the requesting non-AP MLD |
| | needs that information, it can set the |
| | corresponding bit to 1. Otherwise the bit |
| | can be set to 0. |
| Timeout | A timeout value to indicate the duration |
| value | for which the above request can be |
| | considered as valid. |
| Token | A token for the current request. The response |
| | frame can carry the same token. Thus, the |
| | STA can know which request the response |
| | corresponds to. |

The above information can be either carried in a new information element/frame or as a part of any of the existing frames in the 802.11 standard.

According to one embodiment, the response frame transmitted by the AP MLD to the non-AP MLD can contain at least one or more of the information fields indicated in Table 2.

TABLE 2
Information fields that can be present in the response frame
transmitted by the AP MLD to the non-AP MLD

| Information field | Description |
|---|---|
| Reason code | A field to indicate the reason for information |
| | request. E.g., responding to a request |
| | from the non-AP MLD. |
| Token | A token for the response. The response frame |
| | can carry the same token as in the |
| | corresponding request frame. Thus, the |
| | STA can know which request the |
| | response corresponds to. |
| AP identifier | Information to indicate the APs present in the |
| | vicinity. This can either be a list of APs |
| | in the vicinity or a list of recommended |
| | APs that the non-AP MLD can roam to. |
| | E.g., this can be the MAC address, SSID, AP |
| | MLD ID, etc. The list can also be ordered |
| | with respect to priority/preference/ |
| | recommendation level. E.g., highest priority |
| | first and others arranged in order of |
| | decreasing priority. This can help the non- |
| | AP MLD to understand which AP MLDs |
| | it can attempt to roam to first. |
| Channel | Information about the operating channel(s) of |
| information | the APs in the vicinity. E.g., channel number. |
| | The information can be arranged inside an |
| | information element. There can be more than |
| | one operating channel information inside an |
| | information element corresponding to one AP |
| | MLD in the vicinity (one channel information |
| | for each AP STA affiliated with the AP MLD). |
| | These information elements can be arranged in |
| | the same order in which the AP identifiers are. |
| | Thus, the STA can know which element |
| | corresponds to which AP. This information |
| | can help the STA to identify the channels that |
| | it needs to scan to search for candidate APs. |
| Bandwidth | Information about the bandwidth(s) of the APs |
| information | in the vicinity. E.g., 320 MHz. The information |
| | can be arranged inside an information element. |
| | There can be more than one bandwidth information |
| | inside an information element corresponding |
| | to one AP MLD in the vicinity (bandwidth |
| | information for each AP STA affiliated with |
| | the AP MLD). These information elements |
| | can be arranged in the same order in which |
| | the AP identifiers are. Thus, the STA can know |
| | which element corresponds to which AP. |
| AP capabilities | Information about the capabilities supported at |
| | the APs in the vicinity. E.g., R-TWT support. |
| | This information can be in the form of a bitmap |
| | each of whose bit can correspond to a particular |
| | capability. The AP can set the bit corresponding |
| | to a particular capability to 1 to indicate the |
| | support for that capability. |
| | If the non-AP MLD prefers an AP |
| | MLD with a particular feature support, |
| | this information can enable the non-AP |
| | MLD to shorten the scan phase by only |
| | searching candidate APs amongst |
| | the ones that support the desired feature(s). |
| Traffic load | Information about the traffic load at the APs in |
| information | the vicinity. The information can be arranged |
| | inside an information element. There can be |
| | more than one traffic load information inside an |
| | information element corresponding to one AP |
| | MLD in the vicinity (traffic load information |
| | for each AP STA affiliated with the AP MLD). |
| | These information elements can be arranged |
| | in the same order in which the AP identifiers |
| | are. Thus, the STA can know which element |
| | corresponds to which AP. |
| | This information can enable the |
| | STA to roam to a lightly loaded |
| | AP in the vicinity if it prefers to do so. |
| Queuing delay | Information about the queuing delays at the |
| information | APs in the vicinity. E.g., this can be |
| | information about the queuing delay for |
| | each AC at an AP in the vicinity. The |
| | information can be arranged inside an |
| | information element. There can be more |
| | than one queuing delay information inside |
| | an information element corresponding |
| | to one AP MLD in the vicinity (queuing |
| | delay information for each AP STA affiliated |
| | with the AP MLD). These information |
| | elements can be arranged in the same order in |
| | which the AP identifiers are. Thus, |
| | the STA can know which element |
| | corresponds to which AP. |
| | This information can enable the STA to roam |
| | to APs that can provide lower queuing delay |
| | for a particular traffic type. For instance, if |
| | the STA has ongoing video traffic and wants |
| | to move to an AP where the queuing delay |
| | for video traffic type is low, this information |
| | field can be useful for the STA. |
| Management | The current AP can also provide to the STA, |
| frame | one or more of the information fields from |
| information | any of the management frames (e.g., beacons, |
| | probe responses, etc.) that are advertised by the |
| | APs in the vicinity. |

Upon receiving the information from the AP, the STA can then shorten the scan time by first searching/attempting connection with APs that fit within its selection criteria and/or are highest priority/preference/recommended.

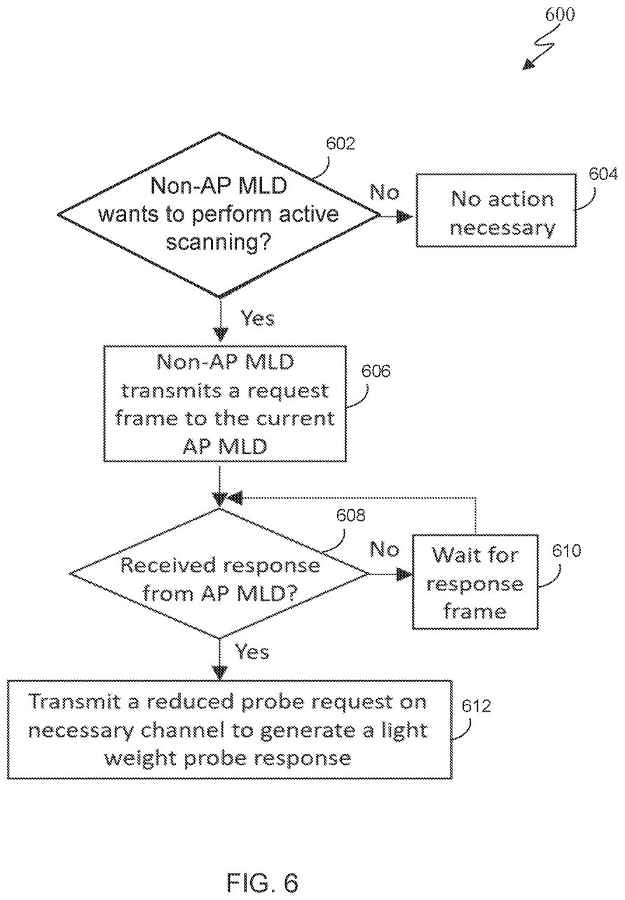

FIG. 6 illustrates an example method 600 for sending a probe request according to embodiments of the present disclosure. The embodiment of the example method 600 for sending a probe request shown in FIG. 6 is for illustration only. Other embodiments of the example method 600 for sending a probe request could be used without departing from the scope of this disclosure.

As illustrated in FIG. 6, the method 600 begins at step 602, where a determination is made whether the non-AP MLD wants to perform active scanning. If the non-AP MLD does not want to perform active scanning, then no action is necessary as illustrated at step 604. If the non-AP MLD wants to perform active scanning, then at step 606, the non-AP MLD transmits a request frame to the current AP MLD. At step 608, a determination is made whether a response frame is received from the AP MLD. If a response frame is not received from the AP MLD, then at step 610, the non-AP MLD waits for a response frame and the method reverts to step 608. If a response frame is received from the AP MLD, then at step 612, the non-AP MLD can transmit a reduced probe request on a channel to generate a light weight probe response.

According to one embodiment, as shown in FIG. 6, the non-AP MLD can send probe requests (targeted for APs in the vicinity) to the current AP MLD instead of sending them to the APs in the vicinity. Further according to this embodiment, the non-AP MLD can receive probe responses or one or more information fields present in a probe response frame of the APs in the vicinity from the current AP MLD. The non-AP MLD can transmit a request frame to the current AP MLD that encapsulates one or more probe requests frame or information items contained in those probe request frames can be encapsulated in a single probe request frame. The content of the request frame can be as shown in Table 3.

TABLE 3
Information that can be present in the request frame

| Information field | Description |
|---|---|
| Dialogue token | A token for the request frame. The AP |
| | can include the same token in the |
| | response frame. |
| Probe request list | A list of probe requests that the non-AP |
| | MLD would have transmitted to APs |
| | in the vicinity. |
| Probe request info | Alternatively, the non-AP MLD can |
| list | send one or more fields of the probe |
| | request for each AP MLD instead of |
| | sending the entire probe request |
| | frame. These fields for each AP MLD |
| | can be put inside a list. Information |
| | for each AP MLD in the vicinity can |
| | be preceded with an AP identifier |
| | (e.g., AP MLD ID, MAC address, etc.) |
| | to indicate that the following information |
| | corresponds to that AP MLD. Alternatively, |
| | the information for each AP MLD can |
| | be inserted inside an information element |
| | and such information elements can be |
| | arranged in the same order as the |
| | AP identifier list below. |
| AP identifier list | A list to identify the APs in the vicinity |
| | that the non-AP MLD intends to probe. |
| | E.g., list of AP MLD ID, MAC address, etc. |

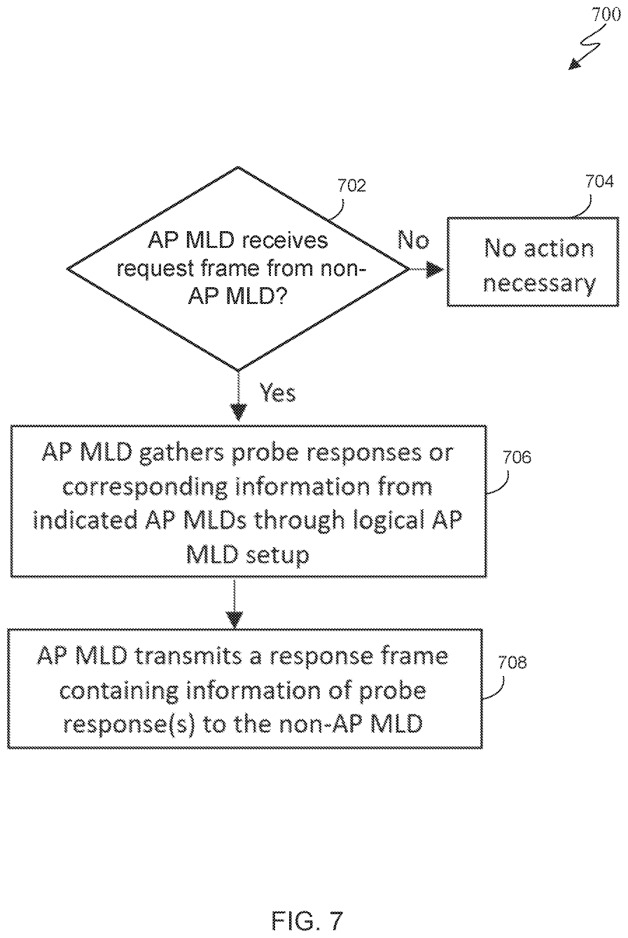

FIG. 7 illustrates an example method 700 for sending a response frame according to embodiments of the present disclosure. The embodiment of the example method 700 for sending a response frame shown in FIG. 7 is for illustration only. Other embodiments of the example method 700 for sending a response frame could be used without departing from the scope of this disclosure.

As illustrated in FIG. 7, the method 700 begins at step 702, where a determination is made whether the AP MLD receives a request frame from the non-AP MLD. If the AP MLD does not receive a request frame, then no action is necessary as illustrated at step 704. If the AP MLD receives a request frame from the non-AP MLD, then at step 706, the AP MLD can gather probe responses or corresponding information from indicated AP MLDs through the logical AP MLD setup. At step 708, the AP MLD can transmit a response frame containing information of probe response(s) to the non-AP MLD.

Upon receiving the request frame from the non-AP MLD, the current AP MLD can gather information via the logical AP MLD stack if one exists with the corresponding AP MLD in the vicinity or based on the information that it has heard from APs in the vicinity. Otherwise, the current AP MLD can first setup a logical AP MLD stack with the AP MLD in the vicinity and then gather information. Upon gathering the information, the AP MLD can then transmit a response frame to the non-AP MLD as shown in FIG. 7. This content of the response frame can be as shown in Table 4.

TABLE 4
Information that can be present in the response frame

| Information field | Description |
|---|---|
| Dialogue token | A token for the response frame. This can |
| | be the same token as the one in the |
| | corresponding request frame. |
| Probe response | A list of probe responses that the APs |
| list | in the vicinity would have transmitted |
| | to the non-AP MLD. |
| Probe response | The non-AP MLD can send one or more |
| info list | fields of the probe response frame for |
| | each AP MLD instead of sending the |
| | entire probe response frame. These fields |
| | for each AP MLD can be put inside a list. |
| | Information for each AP MLD in the vicinity |
| | can be preceded with an AP identifier |
| | (e.g., AP MLD ID, MAC address, etc.) to |
| | indicate that the following information |
| | corresponds to that AP MLD. Alternatively, |
| | the information for each AP MLD can |
| | be inserted inside an information element |
| | and such information elements |
| | can be arranged in the same |
| | order as the AP identifier list below. |
| AP identifier list | A list to identify the APs in the vicinity |
| | for which the probe response frame or |
| | one or more fields of the probe response |
| | frame have been included. E.g., list |
| | of AP MLD ID, MAC address, etc. |
| Logical AP | An information item that can indicate |
| MLD AP | which of the above APs are a part |
| indication | of the logical AP MLD. E.g., a flag, |
| | a bit that can take a predetermined |
| | value to make the indication. |

Once the non-AP MLD has obtained the probe response information from the current AP MLD, it can then switch to the channels of the corresponding APs and transmit a reduced probe request. This probe request can only contain basic information necessary to generate a light weight probe response (e.g., AP information). The light weight probe response frame can exclude all the information that the non-AP MLD has already obtained. The purpose of sending this light weight probe response can be to enable the non-AP MLD to obtain information that could not have been obtained through the current AP MLD (e.g., RSSI to the AP MLD in the vicinity).

The response frame can also be transmitted by the current AP MLD in an unsolicited manner. For example, if the current AP MLD feels that the signal strength to the non-AP MLD is becoming weak then it can send the above frame to trigger the non-AP MLD to roam to a new AP.

According to one embodiment, the non-AP MLD can make one or more of the STAs affiliated with it as a designated scanner(s). When one or more STAs are assigned as designated scanners by the non-AP MLD, it can transmit a frame containing one or more of the information stated in Table 5 below to inform the AP about its current configuration. Further, according to this embodiment, the designated scanner can be used for both traffic reception and scanning or solely for the purpose of performing scanning functionalities. When used for both traffic reception and scanning, the non-AP MLD can indicate in the request frame to the AP MLD the time window in which the scanning functionalities will be performed. This can enable the AP MLD to buffer traffic in those windows and transmit them to the STA once the window is over.

TABLE 5
Information that can be present in the frame
transmitted by the non-AP MLD to the AP MLD
upon designated scanner assignment

| Field | Description |
|---|---|
| Designated | List of STAs that are designated as scanners by |
| scanner STA | the non-AP MLD. For instance, this can be the |
| identifier | list of MAC address of the STAs. This can enable |
| | the AP MLD to understand which STAs need to |
| | be treated as designated scanners. |
| Token | A token for the frame carried by the non-AP |
| | MLD. The same token can be carried in the |
| | response frame from the AP MLD. |
| Scanning | The duration for which the STAs affiliated |
| duration | with the non-AP MLD have been assigned |
| | as scanners. For instance, this can be in |
| | terms of TBTT, TU, etc. |
| Traffic | Information about the links to which the |
| assignment | traffic of the scanning STAs need to be |
| information | diverted to. For instance, this can be a set |
| | of preferred link(s) indicated by the non-AP |
| | MLD. The AP MLD can then divide traffic |
| | load of the scanning STA's link among |
| | these preferred link(s). |
| Scanning | For each scanning STA, the non-AP MLD can |
| schedule | provide a schedule to indicate to the AP MLD |
| | the time window in which a particular |
| | channel will be scanned by the STA. If the |
| | scanning STA is being used for the purpose of |
| | both scanning and data traffic reception, |
| | this can enable the AP MLD to buffer the traffic |
| | corresponding to the scanning STA in these |
| | time windows and schedule the STA for reception |
| | of downlink traffic once the window is over. |

Upon receiving the above frame from the non-AP MLD, the AP MLD can send a response frame that can contain one or more of the information fields indicated in Table 6.

TABLE 6
Information that can be present in the response frame
transmitted by the AP MLD to the non-AP MLD

| Field | Description |
|---|---|
| Token | Token indicating the frame this response |
| | frame corresponds to. AP MLD |
| | includes the same token as in the frame |
| | transmitted by the non-AP MLD. |
| Traffic | Information about the link(s) to which the |
| assignment | traffic of the scanning STAs has been |
| information | assigned by the AP MLD. For instance, |
| | this can be a list of link IDs. The AP can |
| | either use the same set of link(s) indicated |
| | by the non-AP MLD to route the traffic to |
| | or it can chose based on its own consideration. |

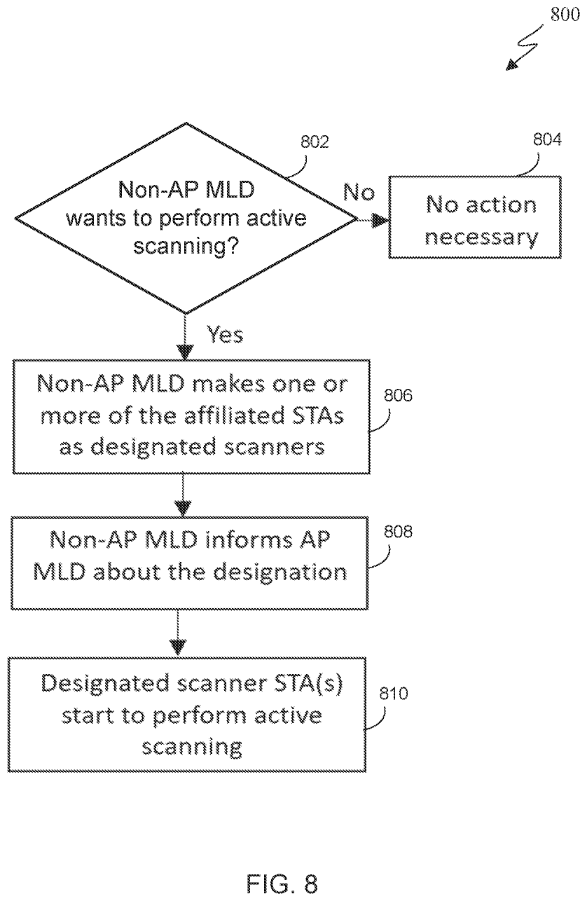

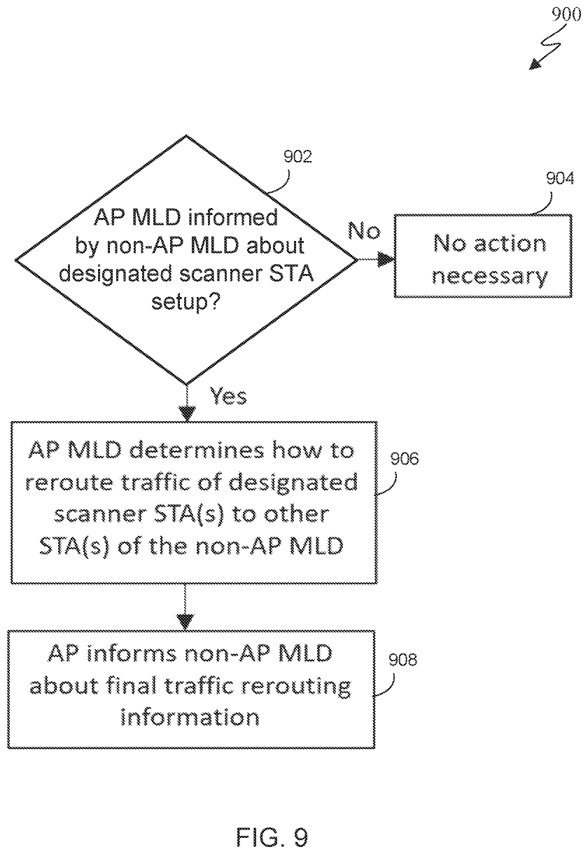

The designated scanner STAs can work together to cover different bands and channels to obtain information about APs in the vicinity. The procedure for obtaining the information about different APs in the vicinity can be either the same as the normal scanning procedure or by using the procedures described previously. Once one or more STAs affiliated with the non-AP MLD are made as designated scanners, the traffic of these STAs can be routed by the AP (on its own or upon request by the non-AP MLD). Upon completion of the scanning procedure, the designated scanner STAs can return to normal behavior and start to receive traffic. At this point the non-AP MLD, can a frame to inform the AP MLD that the STAs have resumed normal operation or it can be done in an implicit manner based on the scanning duration field in Table 5. The procedure is as depicted in FIG. 8 and FIG. 9.

FIG. 8 illustrates an example method 800 for designating a scanner STA according to embodiments of the present disclosure. The embodiment of the example method 800 for designating a scanner STA shown in FIG. 8 is for illustration only. Other embodiments of the example method 800 for designating a scanner STA could be used without departing from the scope of this disclosure.

As illustrated in FIG. 8, the method 800 begins at step 802, where a determination is made whether the non-AP MLD wants to perform active scanning. If the non-AP MLD does not want to perform active scanning, then no action is necessary as illustrated at step 804. If the non-AP MLD wants to perform active scanning, then at step 806, the non-AP MLD can make one or more of the affiliated STAs as designated scanners. At step 808, the non-AP MLD can inform the AP MLD about the designation. At step 810, the designated scanner STA9s) start to perform active scanning.

FIG. 9 also illustrates an example method 900 for designating a scanner STA according to embodiments of the present disclosure. The embodiment of the example method 900 for designating a scanner STA shown in FIG. 9 is for illustration only. Other embodiments of the example method 900 for designating a scanner STA could be used without departing from the scope of this disclosure.

As illustrated in FIG. 9, the method 900 begins at step 902, where a determination is made whether the AP MLD is informed by the non-AP MLD about a designated scanner setup. If the AP MLD is not informed about the designated scanner setup, then no action is necessary as illustrated at step 904. If the AP MLD is informed about the designated scanner setup, then at step 906, the AP MLD can determine how to re-route traffic of designated scanner STA(s) to other STAs of the non-AP MLD. At step 908, the AP MLD can inform the non-AP MLD about the final traffic re-routing information.

It should be appreciated by those skilled in the art that the embodiments described in the present disclosure can be applicable for both single link and multi-link operation and are not limited to either, and that the embodiments in the present disclosure can be applicable for other features beyond logical AP MLD.

It should be appreciated by those skilled in the art that the logical AP MLD can also be referred to by other names such as non-collocated AP MLD, single mobility domain AP MLD, etc., and that the term current AP MLD can also refer to the current physical AP MLD.

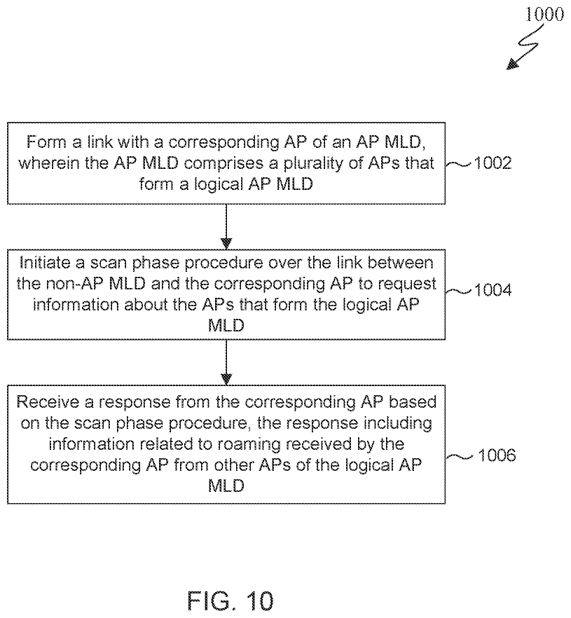

FIG. 10 illustrates a flowchart of a method 1000 for wireless communication performed by a non-AP MLD that comprises STAs according to embodiments of the present disclosure. The embodiment of the method 1000 for wireless communication performed by a non-AP MLD that comprises STAs shown in FIG. 10 is for illustration only. Other embodiments of the method 1000 for wireless communication performed by a non-AP MLD that comprises STAs could be used without departing from the scope of this disclosure.

As illustrated in FIG. 10, the method 1000 begins at step 1002, where the non-AP MLD forms a link with a corresponding AP of an AP MLD, wherein the AP MLD comprises a plurality of APs that form a logical AP MLD. At step 1004, the non-AP MLD initiates a scan phase procedure over the link between the non-AP MLD and the corresponding AP to request information about the APs that form the logical AP MLD. At step 1006, the non-AP MLD receives a response from the corresponding AP based on the scan phase procedure, the response including information related to roaming received by the corresponding AP from other APs of the logical AP MLD.

In one embodiment, the non-AP MLD determines a new AP to roam to from the other APs of the logical AP MLD based on the information related to roaming.

In one embodiment, the non-AP MLD informs the corresponding AP about the new AP to roam to.

In one embodiment, the scan phase procedure comprises an active probing procedure, where the non-AP MLD transmits a probe request to the corresponding AP; receives a probe response from the corresponding AP based on the probe request, the probe response including information related to roaming received by the corresponding AP from the other APs of the logical AP MLD; and transmits a reduced probe request to the other APs of the logical AP MLD.

In one embodiment, the probe request comprises a frame that encapsulates one or more probe request frames or one or more fields of the probe request frames.

In one embodiment, the probe response comprises one or more information fields present in a probe response frame received by the corresponding AP from the other APs of the logical AP MLD.

In one embodiment, to perform the scan phase procedure, the non-AP MLD identifies one of the STAs of the non-AP MLD as a designated scanner; informs the corresponding AP about the designated scanner; and performs an active scanning procedure via the designated scanner.

In one embodiment, to perform the active scanning procedure, the non-AP MLD transmits, to the corresponding AP, a frame that includes information about a current configuration of the designated scanner.

The above flowcharts illustrate example methods that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a non-access point (AP) multi-link device (MLD) (non-AP MLD) that includes stations (STAs), the method comprising:
forming a link with a corresponding AP of an AP MLD, wherein the AP MLD comprises a plurality of APs that form a logical AP MLD;
initiating a scan phase procedure over the link between the non-AP MLD and the corresponding AP to request information about the APs that form the logical AP MLD; and
receiving a response from the corresponding AP based on the scan phase procedure, the response including information related to roaming received by the corresponding AP from other APs of the logical AP MLD.

2. The method of claim 1, further comprising determining a new AP to roam to from the other APs of the logical AP MLD based on the information related to roaming.

3. The method of claim 2, further comprising informing the corresponding AP about the new AP to roam to.

4. The method of claim 1, wherein the scan phase procedure comprises an active probing procedure, the active probing procedure comprising:
transmitting a probe request to the corresponding AP;
receiving a probe response from the corresponding AP based on the probe request, the probe response including information related to roaming received by the corresponding AP from the other APs of the logical AP MLD; and
transmitting a reduced probe request to the other APs of the logical AP MLD.

5. The method of claim 4, wherein the probe request comprises a frame that encapsulates one or more probe request frames or one or more fields of the probe request frames.

6. The method of claim 4, wherein the probe response comprises one or more information fields present in a probe response frame received by the corresponding AP from the other APs of the logical AP MLD.

7. The method of claim 1, wherein the scan phase procedure comprises:
identifying one of the STAs of the non-AP MLD as a designated scanner;
informing the corresponding AP about the designated scanner; and
performing an active scanning procedure via the designated scanner.

8. The method of claim 7, wherein the active scanning procedure comprises transmitting, to the corresponding AP, a frame that includes information about a current configuration of the designated scanner.

9. A non-access point (AP) multi-link device (MLD) (non-AP MLD), comprising:
stations (STAs), each comprising a transceiver; and
a processor operably coupled to the transceiver, the processor configured to:
form a link with a corresponding AP of an AP MLD via one or more of the transceivers, wherein the AP MLD comprises a plurality of APs that form a logical AP MLD;
initiate a scan phase procedure over the link between the non-AP MLD and the corresponding AP to request information about the APs that form the logical AP MLD; and
receive, via the one or more transceivers, a response from the corresponding AP based on the scan phase procedure, the response including information related to roaming received by the corresponding AP from other APs of the logical AP MLD.

10. The non-AP MLD of claim 9, wherein the processor is further configured to determine a new AP to roam to from the other APs of the logical AP MLD based on the information related to roaming.

11. The non-AP MLD of claim 10, wherein the processor is further configured to inform the corresponding AP about the new AP to roam to.

12. The non-AP MLD of claim 9, wherein the scan phase procedure comprises an active probing procedure, and to perform the active probing procedure, the processor is configured to:
transmit, via one or more of the transceivers, a probe request to the corresponding AP;
receive, via the one or more transceivers, a probe response from the corresponding AP based on the probe request, the probe response including information related to roaming received by the corresponding AP from the other APs of the logical AP MLD; and
transmit, via the one or more transceivers, a reduced probe request to the other APs of the logical AP MLD.

13. The non-AP MLD of claim 12, wherein the probe request comprises a frame that encapsulates one or more probe request frames or one or more fields of the probe request frames.

14. The non-AP MLD of claim 12, wherein the probe response comprises one or more information fields present in a probe response frame received by the corresponding AP from the other APs of the logical AP MLD.

15. The non-AP MLD of claim 9, wherein to perform the scan phase procedure, the processor is further configured to:
identify one of the STAs of the non-AP MLD as a designated scanner;
inform the corresponding AP about the designated scanner; and
perform an active scanning procedure via the designated scanner.

16. The non-AP MLD of claim 15, wherein to perform the active scanning procedure, the processor is further configured to transmit, to the corresponding AP via one or more of the transceivers, a frame that includes information about a current configuration of the designated scanner.

17. An access point (AP) multi-link device (MLD) (AP MLD), comprising:
a plurality of access points (APs), each comprising a transceiver configured to communicate over a link with a corresponding station (STA) of a non-AP MLD, wherein the plurality of APs form a logical AP MLD; and
a processor operably coupled to the transceiver, the processor configured to:
receive, via one or more of the transceivers, a scan phase procedure request over the link between the AP MLD and the corresponding STA to request information about the APs that form the logical AP MLD; and
transmit a response to the corresponding STA based on the scan phase procedure, the response including information related to roaming received from other APs of the logical AP MLD.

18. The AP MLD of claim 17, wherein the scan phase procedure comprises an active probing procedure, and to perform the active probing procedure, the processor is further configured to:
receive, via one or more of the transceivers, a probe request from the corresponding STA;
transmit, via the one or more transceivers, a probe response based on the probe request, the probe response including information related to roaming received from the other APs of the logical AP MLD; and
receive, via the one or more transceivers, a reduced probe request.

19. The AP MLD of claim 18, wherein the probe request comprises a frame that encapsulates one or more probe request frames or one or more fields of the probe request frames.

20. MLD of claim 18, wherein the probe response comprises one or more information fields present in a probe response frame received from the other APs of the logical AP MLD.
